(19) United States
(12) Patent Application Publication
(10) Pub. No.: US 2026/0280008 A1
(43) Pub. Date: Sep. 17, 2026

(54) POWER UNIT MODULE FOR BATTERY-POWERED POWER EQUIPMENT AND METHOD OF MOUNTING SAME ONTO FRAME MEMBER OF POWER EQUIPMENT

(71) Applicant: Honda Motor Co., Ltd., Tokyo (JP)

(72) Inventor: Christopher Todd WALKER, Hillsborough, NC (US)

(21) Appl. No.: 19/079,516

(22) Filed: Mar. 14, 2025

(51) Int. Cl. H01M 50/247; A01D 34/67; A01D 34/78; A01D 34/81; A01D 101/00; H01M 50/204; H01M 50/264; H01M 50/271; H01M 50/284; H02K 11/33

(52) U.S. Cl. CPC H01M 50/247; A01D 34/67; A01D 34/78; A01D 34/81; H01M 50/204; H01M 50/264; H01M 50/271; H01M 50/284; H02K 11/33; A01D 2101/00; H01M 2220/30

(57) ABSTRACT

A power unit module for a battery-powered power equipment can include a battery tray, a battery latching mechanism, a housing, and at least one battery. The housing can include a pair of access openings spaced away from the battery tray in a first direction such that the battery tray is located between the access openings. The power unit can include a rear light emitting diode assembly, a pair of access panels, and a printed circuit board. The rear light emitting diode assembly can be mounted onto one of the battery tray and the housing and facing in a second direction, and each of access panels can be removably connected to the housing and close a respective one of the access openings. The printed circuit board can be mounted inside of the housing, and the controller can be configured to be in electrical communication with the battery.

### BACKGROUND

The disclosed subject matter relates to a power unit module for a battery-powered power equipment. More particularly, the disclosed subject matter relates to a power unit module that can be used with any one of a plurality of different types of battery-powered power equipment and methods associated therewith.

Power equipment such as, but not limited to, a lawnmower, a snow blower, a tiller, a lawn edger, an aerator, a string trimmer, a hedge trimmer, a power washer, and a water pump can include an electric motor and a rechargeable battery that supplies electrical power to the electric motor. The electric motor can drive the tool and/or propel the power equipment. The battery can be removed from the power equipment for charging on a separate charger that is external to the power equipment.

The removable battery can be referred to as a battery pack or a battery module and can include a housing, a connector and a plurality of individual battery cells. The battery cells can be connected to each other in series and/or in parallel to obtain the desired current and voltage output for the electric motor of the power equipment. The battery cells can be contained within the housing and in electrical communication with the connector. The connector can be configured to be electrically connected to a mating connector on the power equipment and separately electrically connected to a mating connector of the external charger. The power equipment can include a single battery pack or a plurality of battery packs that are connected to each other in series and/or in parallel to obtain the desired current and voltage output for the electric motor of the power equipment.

### SUMMARY

Some embodiments are directed to a power unit module for a battery-powered power equipment, the power unit module can include a battery tray, a battery latching mechanism, a housing, a rear light emitting diode assembly, a left-hand access panel, a right-hand access panel and a printed circuit board. The battery tray can be configured to removably receive at least one battery. The battery latching mechanism can be configured to engage and lock the battery to the battery tray if the battery is mounted onto the battery tray. The housing can extend in a first direction, a second direction that is orthogonal to the first direction, and a third direction that is orthogonal to the first direction and the second direction. The housing can include a left access opening that is spaced away from the battery tray in the first direction, and a right access that is opening spaced away from the battery tray in the first direction such that the battery tray is located between the right access opening and the left access opening. The rear light emitting diode assembly can be mounted onto one of the battery tray and the housing and face in the second direction. The left-hand access panel can be removably connected to the housing and closing the left access opening, and the right-hand access panel can be removably connected to the housing and closing the right access opening. The printed circuit board can be mounted inside of the housing and include a controller that is configured to be in electrical communication with the battery if the battery is mounted in the battery tray and the battery latching mechanism locks the battery to the battery tray.

Some embodiments are directed to a power unit module for a battery-powered power equipment, the power unit module can include a battery tray, a battery latching mechanism, a printed circuit board, a housing, a rear light emitting diode assembly, a first access panel, and a second access panel. The battery tray can be configured to removably receive a first battery, and the battery latching mechanism can be configured to engage and lock the first battery to the battery tray if the first battery is mounted onto the battery tray. The printed circuit board can be connected to the battery tray, and can include a controller that is configured to be in electrical communication with the battery if the battery is mounted in the battery tray and the battery latch locks the battery to the battery tray. The housing can enclose the battery tray and include a first opening and a second opening. The rear light emitting diode assembly can be mounted onto one of the battery tray and the housing. The first access panel can be removably connected to the housing to selectively open and close the first opening, and the second access panel can be removably connected to the housing to selectively open and close the second opening.

Some embodiments are directed to a power unit module for a battery-powered power equipment, the power unit module can include a battery tray sub-assembly, a housing, a rear light emitting diode assembly, a left-hand access panel, and a right-hand access panel. The battery tray sub-assembly can include a battery tray configured to removably receive a battery, a bottom cover connected to the battery tray, a battery latching mechanism, and a printed circuit board. The battery latching mechanism can be configured to engage and lock the battery on the battery tray if the battery is mounted onto the battery tray. The battery latch mechanism can be located between the battery tray and the bottom cover and protruding though the battery tray. The printed circuit board can be mounted onto one of the battery tray and the bottom cover, and can include a controller that is configured to be in electrical communication with the battery if the battery is mounted in the battery tray and the battery latch locks the battery to the battery tray. The housing can enclose the battery tray sub-assembly and include a left-hand opening and a right-hand opening. The rear light emitting diode assembly can be mounted onto one of the battery tray and the housing. The left-hand access panel can be removably connected to the housing to selectively open and close the left-hand opening, and the right-hand access panel can be removably connected to the housing to selectively open and close the right-hand opening.

### BRIEF DESCRIPTION OF THE DRAWINGS

The disclosed subject matter of the present application will now be described in more detail with reference to exemplary embodiments of the apparatus and method, given by way of example, and with reference to the accompanying drawings, in which:

FIG. 1 is a perspective view of a first embodiment of a power unit module made in accordance with principles of the disclosed subject matter and mounted on a power equipment.

FIG. 2 is a perspective view of the power unit module of FIG. 1 mounted on a lawnmower.

FIG. 3 is a perspective view the power unit module of FIG. 1 and a battery to be installed into or removed from the power unit module.

FIG. 4A is an exploded perspective view of an upper housing assembly of the power unit module of FIG. 1.

FIG. 4B is an exploded perspective view of a battery tray assembly of the power unit module of FIG. 1.

FIG. 4C is an exploded perspective view of a lower housing assembly of the power unit module of FIG. 1.

FIG. 5 is an exploded perspective view of the battery tray assembly and the battery of the power unit module of FIG. 1.

FIG. 6 is a cross-sectional view of the battery tray assembly and the battery of the power unit module of FIG. 1 with a latch assembly engaging the battery in a locked position.

FIG. 7 is a cross-sectional view of the battery tray assembly and the battery of the power unit module of FIG. 1 with the latch assembly disengaging the battery in an unlocked position.

FIG. 8 is a perspective view of a second embodiment of a power unit module made in accordance with principles of the disclosed subject matter and mounted on a power equipment.

FIG. 9 is a perspective view the power unit module of FIG. 8 with a lid in the opened position and a pair of batteries installed in the power unit module.

FIG. 10A is an exploded perspective view of an upper housing assembly of the power unit module of FIG. 8.

FIG. 10B is an exploded perspective view of a battery tray assembly of the power unit module of FIG. 8.

FIG. 10C is an exploded perspective view of a lower housing assembly of the power unit module of FIG. 8.

### DETAILED DESCRIPTION OF EXEMPLARY EMBODIMENTS

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows.

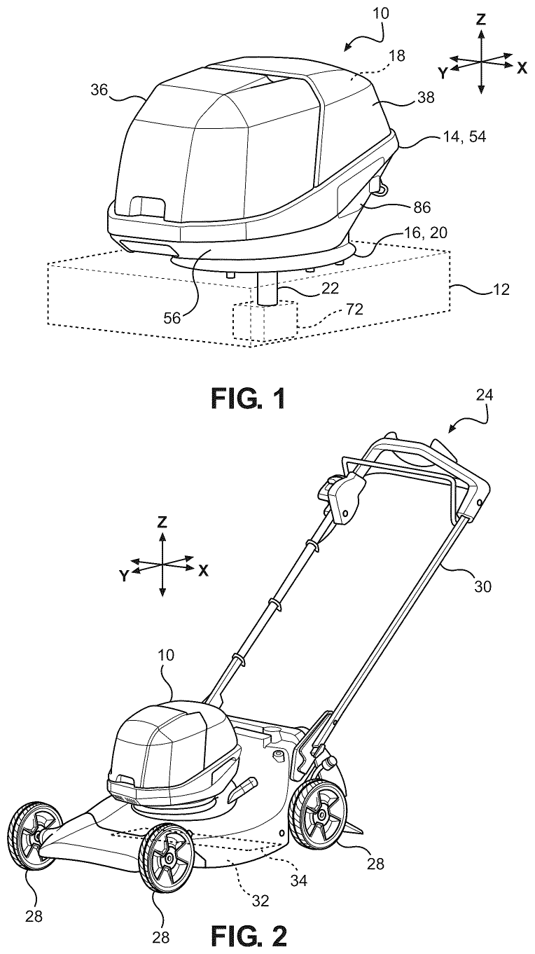

FIG. 1 illustrates an embodiment of a power unit module 10 for a power equipment 12 made in accordance with principles of the disclosed subject matter. The power equipment 12 is schematically illustrated in phantom in FIG. 1 and can be any electrically powered device such as, but not limited to, a lawnmower, a snow blower, a tiller, a lawn edger, an aerator, a string trimmer, a hedge trimmer, a power washer, and a water pump. The power unit module 10 can extend in a first direction X, a second direction Y and a third direction Z, which directions are orthogonal to each other.

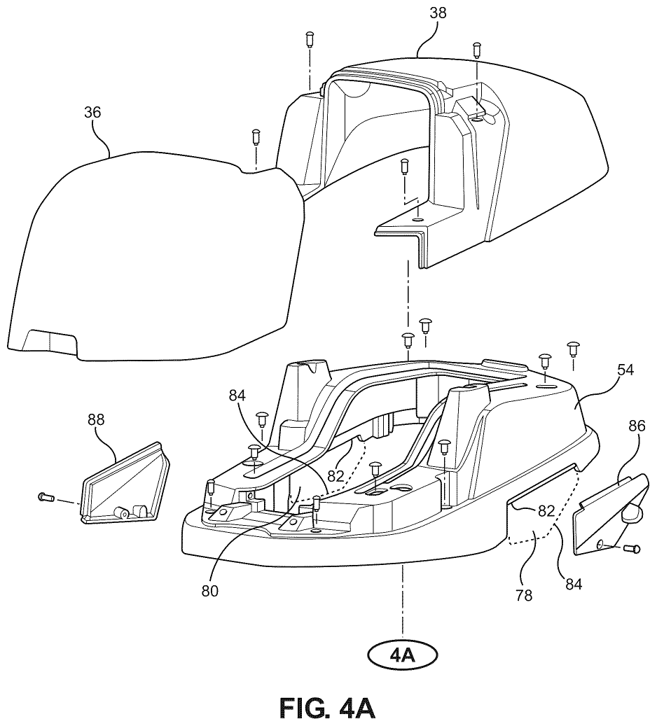

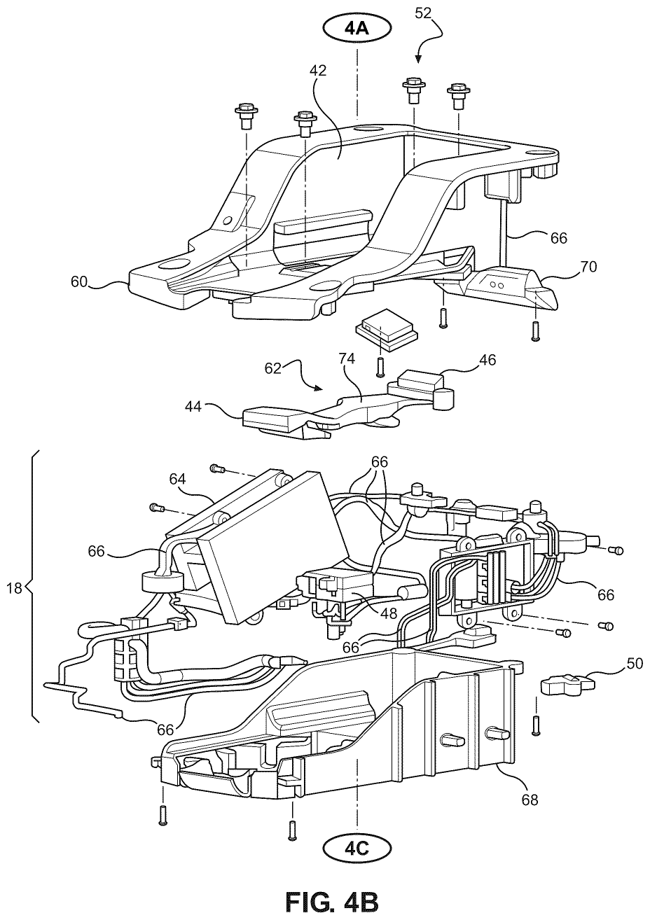

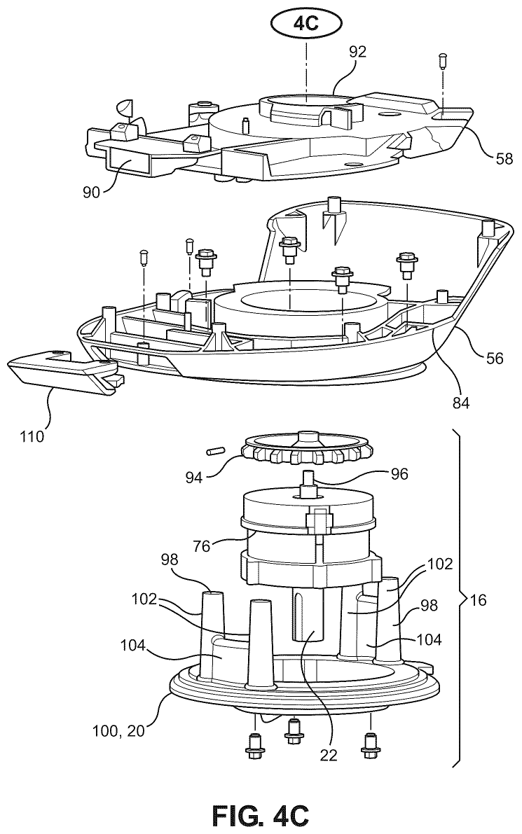

The power unit module 10 can include a housing 14, an electric motor assembly 16 (see also FIG. 4C) and electric/electronic components 18 (see also FIG. 4B) responsible for the function(s) of the power equipment 12. At least a portion of the electric motor assembly 16 and at least a portion of the electrical/electronic components 18 can be contained within the housing 14. Most of the electric motor assembly 16 and the electrical/electronic components 18 are obstructed from view in FIG. 1 by the housing 14 The power unit module 10 can also be referred to as a power unit assembly, a power source module, or a power source assembly.

The electric motor assembly 16 can include a motor plate 20 that is at least partially exposed outside of the housing 14 and an output shaft 22 that extends out of the housing 14 and through the motor plate 20. The motor plate 20 can be configured to secure the power unit module 10 to the power equipment 12 and can be referred to as a mounting plate, a mounting base, or a base. The output shaft 22 can be configured to be connected directly, or indirectly, to a driven structure 72 of the power equipment 12 and/or a propulsion motor of the power equipment 12, if the power equipment 12 is self-propelled. The output shaft 22 can rotate about an axis that is parallel to or substantially parallel to the third direction Z. The driven structure 72 is schematically illustrated in phantom in FIG. 1 and can be any appropriate structure such as, but not limited to a rotating cutting blade, an auger, rotary tines, cutting string, a reciprocating blade, and the operating structure(s) of a fluid pump.

The power equipment 12 can include one or more frame members or other structure that is sufficient to support the power unit module 10 during use of the power equipment 12. In an exemplary embodiment, the power equipment 12 can be configured as a water pump or pressure washer and can include a cubical frame assembly that supports and surrounds the power unit module 10 and a fluid pump that is driven by the power unit module 10. In another exemplary embodiment, the power equipment 12 can be configured as a snow blower or a tiller and can include one or more structural members that support an auger or rotating tines, respectively, that is/are driven by the power unit module 10. In another exemplary embodiment, the power equipment 12 can include a plurality of wheels and one or more structural members, and the power unit module 10 can be mounted onto the structural member(s) and drive at least one of the wheels.

FIG. 2 shows an exemplary power equipment 12 that is configured as a lawnmower 24. The lawnmower 24 can include a mower deck 26, a plurality of wheels 28, a handle 30 and a cutting blade 34. The right rear wheel is obstructed from view in FIG. 2. The wheels 28 can be connected to the mower deck 26 and the blade 34 can be connected to and driven by the output shaft 22 (FIG. 1). The mower deck 26 can contain a cutting chamber 32 in which the blade 34 rotates. The mower deck 26 can be referred to as a cutter housing, a blade housing, a deck, or a frame member. The power unit module 10 can be mounted on the top surface of the mower deck 26 and connected to the blade 34 to rotate the blade 34 in the cutting chamber 32.

The motor plate 20 can be configured to enhance the strength of the power unit module 10 so that the power unit module 10 can be easily and reliably used with any one of the plurality of different power equipment 12. The motor plate 20 can be diecast from any appropriate material such as, but not limited to, aluminum or an aluminum alloy.

Thus, the power unit module 10 can be used with any one of a plurality of differently configured power equipment 12. Further, the power unit module 10 can be developed for function, strength and durability, and ease of assembly regardless of the structure member(s) that is/are available onto which the power unit module 10 is mounted. Further still, the power unit module 10 can include uniquely styled components and be manufactured according to a unique assembly sequence for overall unit construction. These features of the power unit module 10 can reduce the manufacturing cost of the power unit module 10 and the power equipment 12.

Referring to FIGS. 1-3, the housing 14 of the power unit module 10 can include a first lid 36, a second lid 38 and a battery 40. The first lid 36 can be movable relative to a remainder of the housing 14 or removable from the remainder of the housing 14 to permit access to an inside of the housing 14 so that the battery 40 can be installed into and removed from the housing 14. The battery 40 can be installed into and removed from the housing 14 in a direction that is parallel to or substantially parallel to the second direction Y.

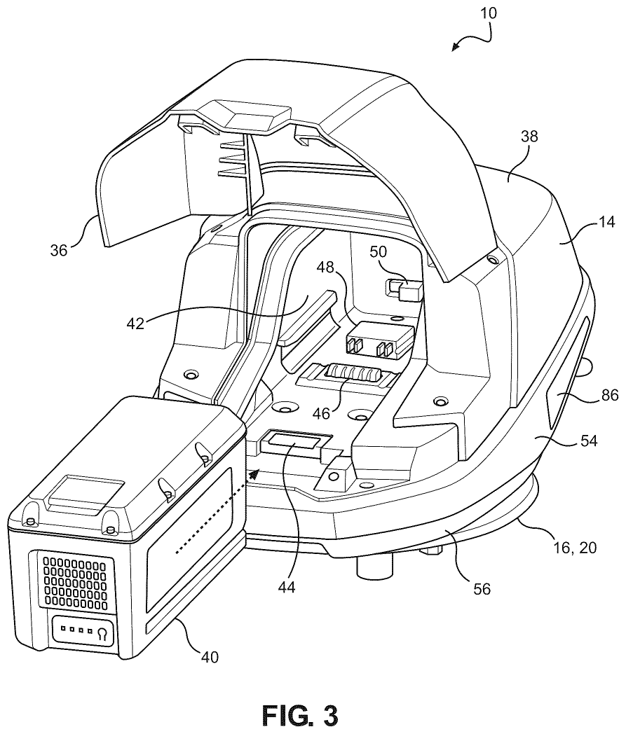

The first lid 36 can pivot between a closed position (FIGS. 1 and 2) and an opened position (FIG. 3). The first lid 36 can pivot about an axis that is parallel to or substantially parallel to the first direction X.

The second lid 38 can be immovably fixed to a remainder of the housing 14 by any appropriate manner such as, but not limited to, threaded fasteners, rivets, clamps, clips, adhesive, welds, snap-fitting structure(s), or any combination of these structures. The first lid 36 can be connected to the second lid 38 in any appropriate manner such as, but not limited to, a shaft, one or more hinges, or one or more pivot pins so that the first lid 36 can move from/to each of the opened position and the closed position.

The battery 40 can be installed into and removed from the housing 14 in a direction that is parallel to or substantially parallel to the second direction Y. If the power equipment 12 is on a flat, horizontal surface and the first lid 36 is placed in the opened position, then the battery 40 can be installed/removed in a horizontal direction. This orientation can support at least a portion of the weight of the battery 40, and can allow the user to reduce the gripping force applied to the battery 40 and more easily maneuver the battery 40 into and out of the housing 14. Thus, the horizontal orientation of the battery 40 can facilitate the installation and removal of the battery 40.

Referring to FIG. 3, the housing 14 can include a battery bay 42, a release button 44, a latch button 46, a terminal block 48 and an ejector button 50. The lids 36, 38 can close the battery bay 42 and the first lid 36 can move to the opened position to permit access to the battery bay 42. The release button 44 can be pivotally connected inside the battery bay 42 and each of the latch button 46, the terminal block 48 and the ejector button 50 can protrude through a surface of the battery bay 42 to engage the battery 40 and lock the battery 40 in the battery bay 42.

Each different type of power equipment 12 can have different performance target(s) that can be best met by using a battery 40 that has a maximum capacity rating that best matches the desired performance target(s). For example, a commercial lawnmower used by a professional groundskeeper or landscaper can be operated for many hours every workday. In contrast, a residential lawnmower used by a homeowner can be operated for one hour or a few hours, once per week. Thus, the power consumption by the commercial lawnmower can be significantly greater than the power consumption by the residential lawnmower. A battery 40 that has a high maximum capacity can be best suited for a commercial lawnmower, but the cost of the battery 40 can be too high for a residential lawnmower. Conversely, a battery 40 that has a lower maximum capacity rating may be cost effective for a residential lawnmower, but the capacity is insufficient for use with a commercial lawnmower.

The power unit module 10 and the battery 40 can be configured to be compatible with any of a plurality of batteries 40 that each have a different maximum power rating. Every battery 40 intended for use with the power unit module 10 can include respective structures that engage the latch button 46, the terminal block 48 and the ejector button 50. A battery 40 that has a lower maximum capacity rating might be smaller in size as compared to a battery 40 that has a higher maximum capacity rating. However, all of the batteries 40 can include engaging structures that interact with the latch button 46, the terminal block 48 and the ejector button 50. The engaging structures for all of the batteries 40 can be located at a common, relative spacing such that the all of the batteries 40 can properly interact with the latch button 46, the terminal block 48 and the ejector button 50. Thus, the same power unit module 10 can be used with power equipment that have different performance target(s) and batteries 40 having different physical sizes and/or different maximum capacity ratings. This commonality can reduce the overall cost of the power unit module 10.

Referring to FIGS. 1 and 3, the housing 14 can include an upper housing 54 and a lower housing 56. Referring to FIG. 4C, the power unit module 10 can include a duct plate 58.

FIGS. 4A-4C show an exploded perspective view of respective portions of the power unit module 10 and illustrate an exemplary assembly sequence of a sub-assembly 52, upper housing components 36, 38 54, and lower housing components 16, 56, 58. FIGS. 4A and 4C can be connected to FIG. 4B via the links 4A at the bottom of FIG. 4A and the top of FIG. 4B and the links 4C at the bottom of FIG. 4B and the top of FIG. 4C.

Referring to FIG. 4B, the sub-assembly 52 can be pre-assembled before the upper housing components 36, 38 54 and the lower housing components 16, 56, 58 are connected to any component(s) of the sub-assembly 52. Subsequent to pre-assembling the sub-assembly 52, the upper housing components 36, 38, 54 and the lower housing components 16, 56, 58 can be attached to the sub-assembly 52 in any appropriate order.

Referring to FIG. 4B, the sub-assembly 52 can include the electrical/electronic components 18, a battery tray 60, a battery latching mechanism 62 and a bottom cover 68. The electrical/electronic components 18 can include at least one motor controller assembly 64, a wire harness 66, a rear light emitting diode (LED) assembly 70, and a headlight assembly 110.

The battery tray 60 can form the battery bay 42 and support the battery 40. The rear LED assembly 70 can be mounted onto a rear lower portion of the battery tray 60.

The battery latching mechanism 62, motor controller assembly 64 and the wire harness 66 can be located in a space bound by the battery tray 60 and the bottom cover 68. The motor controller assembly 64 can be mounted onto either one or both of the battery tray 60 and the bottom cover 68.

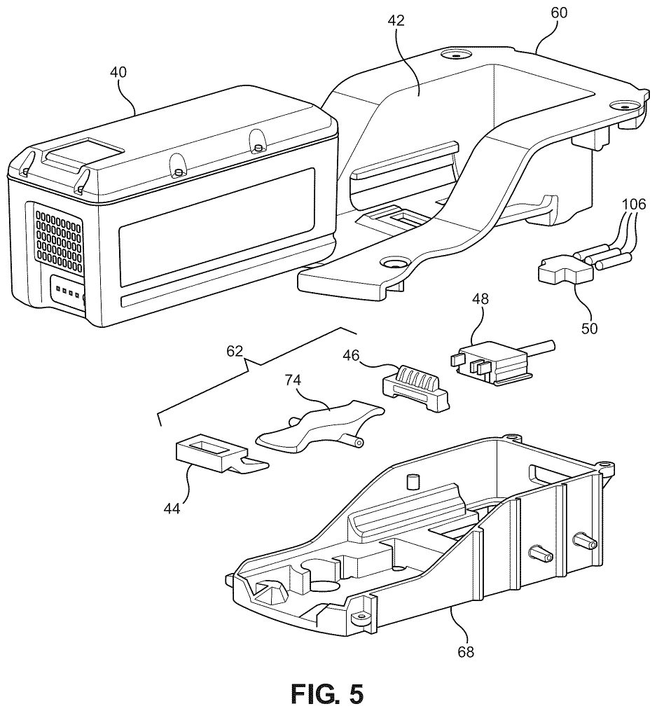

Referring to FIGS. 4B and 5, the battery latching mechanism 62 can include the release button 44, the latch button 46 and a central lever 74. The release button 44 and the latch button 46 can protrude through the bottom wall of the battery tray 60 as shown in FIG. 3.

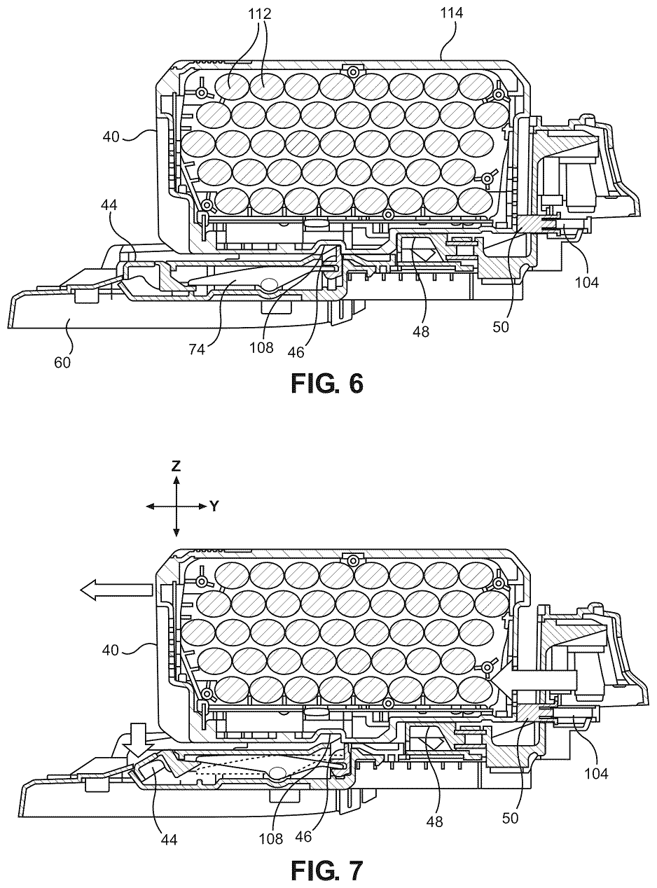

Referring to FIGS. 6 and 7, the release button 44 can be supported by the lower cover 68 to pivot counterclockwise from a released position (FIG. 6) to an unlocking position (FIG. 7). The central lever 74 can be supported by the lower cover 68 to pivot clockwise from a locking position (FIG. 6) to an unlocking position (FIG. 7). The latch button 46 can be slidably supported by the battery tray 60 and the lower cover 68 to move downward along the third direction Z from the a locked position (FIG. 6) to an unlocked position (FIG. 7).

The motor controller assembly 64 can include a printed circuit board, a controller, one or more electronic devices in electrical communication with the controller, a motor driver, and heat sink. The controller can be configured to cause the motor driver to convert a DC power from the battery 40 to an AC power output that drives an electric motor 76 (FIG. 4C). The controller can be configured to send a control signal to the rear LED assembly 70 to cause the rear LED assembly 70 to display at least one of a colored light and a text message.

The wire harness 66 can include a plurality of wires that electrically connect the battery 40, the motor controller assembly 64, the rear LED assembly 70 and the electric motor 76.

The bottom cover 68 can be connected to the battery tray 60 by any appropriate structure such as but not limited to, threaded fasteners, rivets, clamps, clips, adhesive, welds, snap-fitting structure(s), or any combination of these structures.

The upper housing 54 can be mounted onto the battery tray 60 and can be connected to either one or both of the battery tray 60 and the bottom cover 68 by an appropriate structure(s) such as, but not limited to, threaded fasteners, rivets, clamps, clips, adhesive, welds, snap-fitting structure(s), or any combination of these structures.

Returning to FIG. 4A, the housing 14 can include a pair of access openings 78, 80. The first opening 78 and the second opening 80 can be spaced away from each other in the first direction X. An upper portion of each access opening 78, 80 is bound by a lower edge 82 of the battery tray 60 and a lower portion of each access opening 78, 80 is shown in phantom and bound by an upper edge 84 of the lower housing 56. The access openings 78, 80 can provide access inside the housing 14 to perform maintenance and/or repair of component(s) of the power unit module 10 that are enclosed by the housing 14.

The power unit module 10 can include a pair of access panels 86, 88 that are removably mounted onto the housing 14 by any appropriate structure(s) such as, but not limited to, threaded fasteners, rivets, clamps, clips, adhesive, welds, snap-fitting structure(s), or any combination of these structures. The left access panel 86 can close the left access opening 78 and the right access panel 88 can close the right access opening 80.

Referring to FIG. 4C, the duct plate 58 can be mounted onto the lower housing 56 by any appropriate structure(s) such as, but not limited to, threaded fasteners, rivets, clamps, clips, adhesive, welds, snap-fitting structure(s), or any combination of these structures. The duct plate 58 can be include an air inlet 90 and a fan housing 92.

The headlight assembly 110 can include a transparent cover, a printed circuit board (“PCB”) and at least one LED mounted on the PCB. The light assembly 110 can include at least one lens. The lens can be separate from or integrally formed with the transparent cover. The headlight assembly 110 can be mounted onto the lower housing 56 by any appropriate structure(s) such as, but not limited to, threaded fasteners, rivets, clamps, clips, adhesive, welds, snap-fitting structure(s), or any combination of these structures

The electric motor assembly 16 can include the electric motor 76 and a fan 94. The output shaft 22 can include an opposite end 96 that protrudes from the electric motor 76 in the third direction Z. The fan 94 can be mounted onto and driven by the opposite end 96 of the output shaft 22. The fan 94 can be connected to the opposite end 96 of the output shaft 22 by any appropriate structure(s) such as, but not limited to, threaded fasteners, rivets, clamps, clips, adhesive, welds, snap-fitting structure(s), or any combination of these structures.

The motor plate 20 can include a plate base 100 and a plurality of tray stability mounts 98 that protrude from the plate base 100. Each of the mounts 98 can include a pair of fastener columns 102 and a web 104 connected to each fastener column 102 of the pair. The fastener columns 102 can extend through the lower housing 56, the duct plate 58, and the bottom cover 68 to abut a bottom surface of the battery tray 60. Any appropriate structure(s) such as, but not limited to, threaded fasteners, rivets, clamps, clips, adhesive, welds, snap-fitting structure(s), or any combination of these structures can connect the battery tray 60 to the fastener columns 102.

The electric motor 76 can be mounted onto the plate base 100 by any appropriate structure(s) such as, but not limited to, threaded fasteners, rivets, clamps, clips, adhesive, welds, snap-fitting structure(s), or any combination of these structures. The electric motor 76 can be located in a space that is bound by the fastener columns 102.

Referring to FIGS. 5-7, the power unit module 10 can include a plurality of springs 106 that abut the ejector button 50 and bias the ejector button 50 against the battery 40 if the battery 40 is mounted on the battery tray 60 and locked by the battery latching mechanism 62. The springs 106 can bias the ejector button 50 in a direction that is opposite to the insertion direction of the battery 40 into the battery bay 42.

The ejector button 50 can protrude from a rear wall of the battery tray 60 and into the battery bay 42 by a predetermined distance such that the ejector button 50 abuts the battery 40 before the battery 40 is locked by the latch button 46. The battery 40 can abut and push the ejector button 50 in the insertion direction to compress the springs 106 until the battery 40 reaches the fully installed position and the latch button 46 engages a lock recess 108 formed in the bottom surface of the battery 40. That is, the ejector button 50 can move between a retracted position (FIG. 6) and an extended position (FIG. 7) and the ejector button 50 is biased by the springs 106 toward the extended position.

If the latch button 46 is moved from the locked position (FIG. 6) to the unlocked position (FIG. 7), the biasing force of the compressed springs 106 can cause the ejector button 50 to move to the left as viewed in FIGS. 6 and 7 and push the battery 40 out of engagement with the terminal block 48, as shown in FIG. 7.

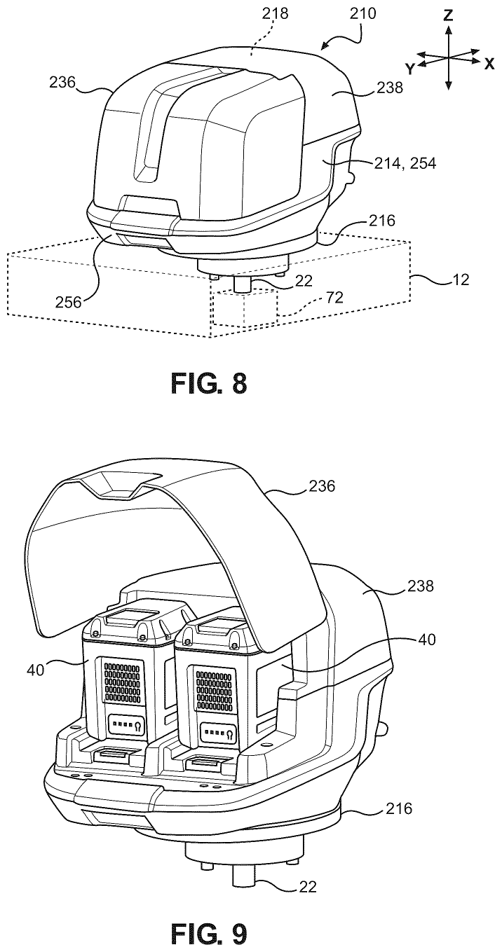

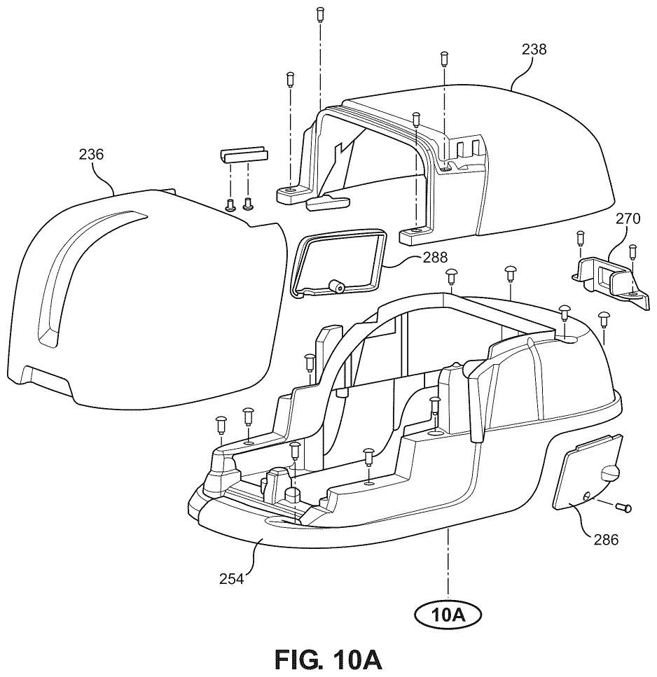

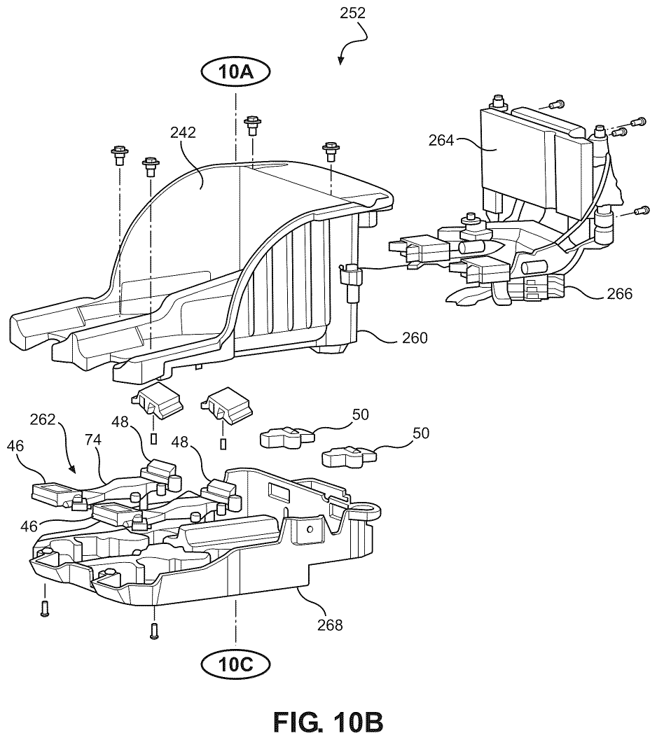

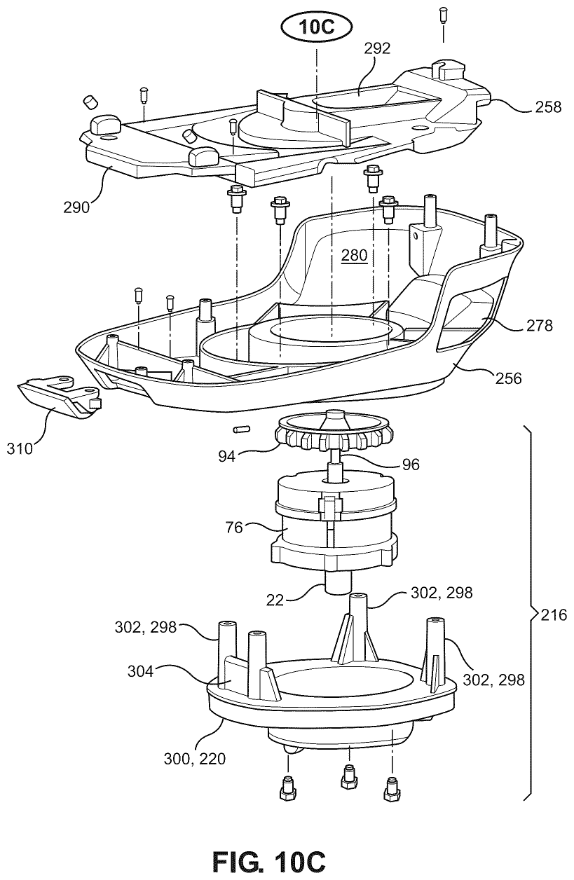

The power unit module 10 can be referred to as a single bay power unit because it houses the single battery 40. FIGS. 8-10C illustrate a power unit module 210 of a second embodiment made in accordance with principles of the disclosed subject matter. The power unit module 210 can be the same as or similar to the power unit module 10 described above with respect to FIGS. 1-7, except that the power unit module 210 can house two batteries 40. The power unit module 210 can include a housing 214, an electric motor assembly 216, electrical/electronic components 218, and a motor plate 220. The housing 214, the electric motor assembly 216, the electrical/electronic components 218, and the motor plate 220 can be same as or similar to the corresponding structures described above with respect to FIGS. 1-7.

The housing 214 can include a first lid, 236, a second lid 238, a sub-assembly 252, an upper housing 254, a lower housing 256 and a duct plate 258. The sub-assembly 252 can be the same as or similar to the sub-assembly 52 of FIG. 4B, except that the sub-assembly 252 can contain two batteries 40. The sub-assembly 252 can include a pair of the ejector buttons 50, a battery tray 260, a battery latching mechanism 262, a motor controller assembly 264 and a wire harness 266. The battery latching mechanism 262 can include a pair of the release buttons 44, a pair of the latch buttons 46, and a pair of the central levers 74.

Instead of being bound by both of the upper housing 254 and the lower housing 256, the lower housing 256 can include the entirety of each of a pair of access openings 278, 280.

The power unit module 210 can include a rear LED assembly 270, a pair of access panels 286, 288 and a headlight assembly 310. The rear LED assembly 270 can be mounted onto a rear side of the upper housing 254. The left access panel 286 can open and close the left access opening 278, and the right access panel 288 can open and close the right access opening 280.

The duct plate 258 can include an air inlet 290 and fan housing 292.

The electric motor assembly 216 can include the electric motor 76, the output shaft 22, the fan 94 connected onto the opposite end 96 of the output shaft 22, and a plurality of tray stability mounts 298. One of the tray stability mounts 298 can include a pair of the fastener columns 302 connected together with a web 304. Two of the tray stability mounts 298 can be standalone fastener columns 302.

A method of assembling the power equipment can use either of the power unit modules 10, 210. The method can include selecting a power equipment 12 from a plurality of different power equipments 12. The plurality of different power equipments 12 can include at least a lawnmower, a pressure washer, a water pump and a tiller.

The method can include inserting the battery 40 in to the battery tray 60, 260 in a horizontal direction. The horizontal direction can be parallel or substantially parallel to the second direction Y if the power equipment 12 is on a flat, horizontal surface.

The method can include selecting the battery 40 from a plurality of batteries 40, where each of the batteries 40 has a respective rating capacity that is different for each of the batteries. For example, one of the batteries 40 can have a maximum power rating lower than the maximum power rating of another one of the batteries 40.

The method can include pre-assembling one of the sub-assemblies 52, 252, mounting the respective one of the upper housings 54, 254 onto the one of the sub-assemblies 52, 252, mounting the respective one of the second lids 38, 238 onto the respective one of the upper housings 54, 254, and mounting the respective one of the first lids 36, 236 onto the respective one of the second lids 38, 238. The method can further include mounting a respective one of each of the duct plates 58, 258, the lower housings 56, 256, and the motor 76 onto the respective one of the motor plates 20, 220. The method can further include mounting the one of the sub-assemblies 52, 252 onto the respective ones of the tray stability mounts 98, 298, and electrically connecting the respective one of the wire harnesses 66, 266 to the electric motor 76.

While certain embodiments of the invention are described above, it should be understood that the invention can be embodied and configured in many different ways without departing from the spirit and scope of the invention.

For example, the first lid 36 can be configured to move between the closed position and the opened position in any appropriate manner such as, but not limited to, rotating, sliding, extending and/or retracting. Instead of being connected onto the second lid 38, the first lid 36 can be connected onto another structure of the housing 14 so that the first lid 36 can move to/from the opened position and the closed position.

Alternate embodiments can combine the first lid 36, 236 and the second lid 38, 238 into a single lid that is movable relative to a remainder of the housing 14, 214 to/from an opened position and a closed position so that the battery(ies) 40 can be installed into or removed from the power unit module 10, 210.

In alternate embodiments, the housing can contain any appropriate number of batteries 40 that is greater than two.

In alternate embodiments, either of the power unit modules 10, 210 can be mounted onto the power equipment 12 with the output shaft 22 extending at an angle relative the vertical direction in order to properly align with the driven device 72. That is, the output shaft 22 can be oriented not to be parallel to the vertical direction.

Referring to FIG. 6, the battery 40 can include a plurality of battery cells 112 and a housing 114. In alternate embodiments, the battery 40 can include a single cell 112. The cells 112 can be electrically connected in series, parallel or a combination of series and parallel connections to achieve the desired power output. In alternate embodiments, the number of battery cells 112 can be more or less than the number shown in FIG. 6.

What is claimed is:

1. A power unit module for a battery-powered power equipment, comprising:
a battery tray configured to removably receive at least one battery;
a battery latching mechanism configured to engage and lock the battery to the battery tray if the battery is mounted onto the battery tray;
a housing extending in a first direction, a second direction that is orthogonal to the first direction, and a third direction that is orthogonal to the first direction and the second direction, the housing including:
a left access opening spaced away from the battery tray in the first direction; and
a right access opening spaced away from the battery tray in the first direction such that the battery tray is located between the right access opening and the left access opening;
a rear light emitting diode assembly mounted onto one of the battery tray and the housing and facing in the second direction;
a left-hand access panel removably connected to the housing and closing the left access opening;
a right-hand access panel removably connected to the housing and closing the right access opening; and
a printed circuit board mounted inside of the housing and including a controller, the controller is configured to be in electrical communication with the battery if the battery is mounted in the battery tray and the battery latching mechanism locks the battery to the battery tray.

2. A method for assembling a battery-powered power equipment and power unit module according to claim 1, comprising:
selecting the battery-powered power equipment from a plurality of differently configured power equipment; and
mounting the power unit module onto a frame member of the power equipment that is selected.

3. The method according to claim 2, wherein the plurality of differently configured power equipment includes a lawnmower, a pressure washer, a water pump, and a tiller.

4. A method of assembling the power unit module according to claim 1, comprising:
inserting the battery into the battery tray along the second direction. wherein
the second direction is a horizontal direction if the power equipment is on a flat, horizontal surface.

5. The method according to claim 4, further comprising:
selecting the battery from a plurality of batteries, each battery of the plurality of batteries includes a respective maximum capacity rating that is different from an other of the batteries.

6. A method of assembling the power unit module according to claim 1, comprising:
pre-assembling a sub-assembly that includes:
the battery tray;
a bottom cover connected to the battery tray;
the battery latching mechanism, the battery latching mechanism is located between the battery tray and the bottom cover;
the rear light emitting diode assembly;
the controller; and
a wire harness that is in electrical communication with the controller and the rear light emitting diode;
mounting an upper housing onto the sub-assembly;
mounting a fixed lid onto the upper housing; and
mounting a movable lid onto the fixed lid.

7. A method of assembling the power unit module according to claim 6, further comprising:
mounting a duct plate, a lower housing, and an electric motor onto a motor plate that includes stability mounts;
mounting the sub-assembly onto the stability mounts of the motor plate; and
electrically connecting the wire harness to the electric motor.

8. A power unit module for a battery-powered power equipment, comprising:
a battery tray configured to removably receive a first battery;
a battery latching mechanism configured to engage and lock the first battery to the battery tray if the first battery is mounted onto the battery tray; and
a printed circuit board connected to the battery tray, the printed circuit board including a controller that is configured to be in electrical communication with the battery if the battery is mounted in the battery tray and the battery latch locks the battery to the battery tray;
a housing enclosing the battery tray and including a first opening and a second opening;
a rear light emitting diode assembly mounted onto one of the battery tray and the housing;
a first access panel removably connected to the housing to selectively open and close the first opening; and
a second access panel removably connected to the housing to selectively open and close the second opening.

9. The power unit module according to claim 8, wherein
the housing includes a lid that moves between a closed position and an opened position, the lid closes access to the battery tray if the lid is in the closed position, and the lid opens access to the battery tray if the lid is in the opened position.

10. The power unit module according to claim 9, wherein
the first opening is spaced away from the second opening in a first direction; and
the lid pivots about an axis that is parallel to the first direction as the lid moves between the closed position and the opened position.

11. The power unit module according to claim 8, further comprising
a second battery latching mechanism configured to engage and lock a second battery if the second battery is mounted onto the battery tray.

12. The power unit module according to claim 11, wherein the housing includes a front lid that pivots between a closed position and an opened position, the front lid closes access to the first battery and the second battery if the front lid is in the closed position and the first and second batteries are locked to the battery tray, and the front lid opens access to the first battery and the second battery if the front lid is in the opened position and the first and second batteries are locked to the battery tray.

13. The power unit module according to claim 8, further comprising:
a motor plate configured to be mounted onto a frame member of the battery-powered power equipment, the motor plate is outside of the housing; and
an electric motor mounted onto the motor plate, contained inside of the housing, in electrical communication with the controller, and including an output shaft extending out of the housing and through the motor plate, wherein
the controller is configured to supply power from the first battery to the electric motor.

14. The power unit module according to claim 13, wherein the motor plate is a diecast aluminum plate.

15. The power unit module according to claim 8, further comprising:
an ejection button supported on the housing, the ejection button is movable between a retracted position and an extended position, and the ejection button engages the first battery if the first battery latching mechanism locks the first battery in the battery tray, the ejection button is in the retracted position if the first battery latching mechanism locks first battery in the battery tray, the ejection button is in the extended position if the first battery is removed from the battery tray and the ejection button is biased from the retracted position toward the extended position.

16. The power unit module according to claim 15, wherein
the first battery latching mechanism includes a latch button that is movable between:
a locked position where the latch button engages the first battery if the first battery is mounted on the battery tray and locked by the first battery latching mechanism, and
a released position where the latch button is disengaged from the first battery, and
the ejection button pushes the first battery along the battery tray in the longitudinal direction if the first battery is on the battery tray and the latch button is in the released position.

17. A power unit module for a battery-powered power equipment, comprising:
a battery tray sub-assembly including:
a battery tray configured to removably receive a battery;
a bottom cover connected to the battery tray;
a battery latching mechanism configured to engage and lock the battery on the battery tray if the battery is mounted onto the battery tray, the battery latch mechanism is located between the battery tray and the bottom cover and protruding though the battery tray; and
a printed circuit board mounted onto one of the battery tray and the bottom cover, the printed circuit board including a controller that is configured to be in electrical communication with the battery if the battery is mounted in the battery tray and the battery latch locks the battery to the battery tray;
a housing enclosing the battery tray sub-assembly and including a left-hand opening and a right-hand opening;
a rear light emitting diode assembly mounted onto one of the battery tray and the housing;
a left-hand access panel removably connected to the housing to selectively open and close the left-hand opening; and
a right-hand access panel removably connected to the housing to selectively open and close the right-hand opening.

18. A lawnmower comprising:
the power unit module according to claim 17;
a mower deck including a cutting chamber;
a plurality of wheels supporting the mower deck;
an electric motor mounted on the mower deck and electrically connected to the controller, the electric motor is contained within the housing and includes an output shaft that extends out of the housing, through the mower deck and into the cutting chamber; and
a cutting blade connected to the output shaft at a location that is in the cutting chamber.

19. The power unit module according to claim 17, wherein
the housing includes:
an upper housing;
a lower housing connected to the upper housing;
a fixed lid connected to the upper housing; and
a movable lid pivotally connected to the fixed lid, and
the battery tray sub-assembly is enclosed by the movable lid, the fixed lid, the upper housing, and the lower housing if the movable lid is in a closed position.

20. The power unit module according to claim 19, further comprising:
a duct plate connected to the lower housing and including an air inlet and a fan housing;
a headlight assembly connected to the lower housing;
a cooling fan located in the fan housing;
an electric motor contained in the lower housing and including an output shaft connected to and driving the cooling fan, the output shaft is configured to drive a driven member.
